(19) United States
(12) Patent Application Publication
(10) Pub. No.: US 2002/0113737 A1
(43) Pub. Date: Aug. 22, 2002

(54) Dual band printed antenna

(75) Inventors: Patrice Brachat, Nice (FR); Jean-Pierre Blot, La Turbie (FR)

Correspondence Address: Lawrence E. Laubscher, Sr., 745 South 23rd Street, Arlington, VA, 22202-2451, US

(73) Assignee: FRANCE TELECOM, PARIS (FR)

(21) Appl. No.: 10/119,084

(22) Filed: Apr. 10, 2002

Related U.S. Application Data
(63) Continuation of application No. PCT/FR00/03134, filed on Nov. 9, 2000.

(30) Foreign Application Priority Data
Nov. 12, 1999 (FR) 99-14329

(51) Int. Cl. H01Q 1/38

(52) U.S. Cl. 343/700 MS

(57) ABSTRACT

The printed antenna is compact and comprises, superposed by dielectric layers, two feed lines having perpendicular microstrips, a ground plane, a first radiating element including a plurality of conductive strips perpendicular to a first coupling slot formed in the ground plane, and a second radiating element superposed on the first element and including a plurality of conductive strips crossing by superposition the first strips and perpendicular to a second coupling slot formed in the ground plane. For example, the elements radiate in the DCS-1800 and GSM radiotelephone frequency bands with perfectly orthogonal fields.

### REFERENCE TO RELATED APPLICATION

This application is a continuation of the PCT International Application No. PCT/FR00/03134 filed on Nov. 09, 2000, which is based on the French Application No. 99-14329 filed on Nov. 12, 1999.

### BACKGROUND OF THE INVENTION

The present invention relates to an elementary circuit antenna for a network for sending and/or receiving telecommunication signals, capable of radiating polarization-duplexed radio-electrical fields, i.e. capable of operating with dual polarization, and of operating in two frequency bands.

Such an antenna is designed to operate in the first frequency band of a cellular radio telecommunications network conforming to the DCS-1800 standard and in a second band of frequencies for a cellular radio communications system conforming to the GSM-900 standard.

In the paper “Multifrequency Operation of Microstrip Antennas Using Aperture Coupled Parallel Resonators” by Frederic Croq and David M. Pozar, IEEE TRANSACTIONS ON ANTENNAS AND PROPAGATION, Vol. 40, No. 11, Nov. 1992, pages 1367 to 1374, a microstrip antenna includes two dielectric layers with a ground conductor plane between them and a microstrip microwave feed line and a radiating element arranged on respective outside faces. The radiating element includes a plurality of parallel conductive strips of different lengths and extending perpendicularly to a coupling slot formed in the ground conductor plane. As a general rule, 2 N conductive strips are distributed symmetrically about an axis transverse to the slot and thus constitute 2 N dipoles excited symmetrically by the slot and resonating at N frequencies.

In the paper “Dual-Frequency and Broad-Band Antennas with Stacked Quarter Wavelength Elements” by Lakhdar Zaïd et al., IEEE TRANSACTIONS ON ANTENNAS AND PROPAGATION, Vol. 47, No. 4, Apr. 1999, pages 654 to 660, a dual band antenna is formed of two stacked quarter-wave elements short-circuited along opposite lateral planes or a common lateral plane.

The antennas described in the above two papers offer bandwidths of less than 10% for a standing wave ratio less than 1.5 and for mean frequencies of the order of a few Gigahertz.

### OBJECT OF THE INVENTION

An object of the present invention is to provide a printed antenna capable of operating in two frequency bands with a standing wave ratio of less than 1.5 over more than 10% of the bandwidth in each band and with electromagnetic field polarizations that are crossed in the two bands so that signals in one band do not interfere with signals in the other band.

### SUMMARY OF THE INVENTION

A printed circuit antenna in accordance with the invention includes, as described in European patent EP-B-484241 in the name of the applicant and in the paper “Dual-Polarization Slot-Coupled Printed Antennas Fed by Stripline” by P. Brachat et al., IEEE TRANSACTIONS ON ANTENNAS AND PROPAGATION, Vol. 43, No. 7, Jul. 1995, pages 738 to 742, a first dielectric layer, a second dielectric layer, a first microwave feed line having a first microwave strip disposed on an outside face of the first layer and a ground conductor plane disposed between the first and second layers, and a first radiating element disposed on another face of the second layer and including a plurality of first narrow conductive strips perpendicular to a first coupling slot in the conductor plane for coupling the first feed line to the first radiating element.

Based on the above single polarization printed antenna structure with single band operation, the invention provides an improvement whereby an antenna according to the invention includes a second microwave feed line constituted by a second microstrip disposed on the outside face of the first layer perpendicularly to the first microstrip and by said ground conductor plane, a third dielectric layer having a face disposed against the first radiating element, and a second radiating element disposed on another face of the third layer and including a plurality of second narrow conductive strips crossing perpendicularly by superposition the first conductive strips and extending perpendicular to a second coupling slot in the ground conductor plane for coupling the second feed line to the second radiating element.

Thanks to the second radiating element, the antenna according to the invention operates at two different frequencies with respective orthogonal polarizations. For example, the first element radiates in the frequency band of the DCS 1800 radiotelephone network and the second element radiates in the frequency band of the GSM radiotelephone network. The antenna in accordance with the invention has the same bandwidth performance as the prior art antenna described in EP-B-484241 and the same polarization purity thanks to the concept of a grid formed by the first strips and the second strips to constitute the first and second radiating elements. The perpendicular arrangement of the first strips relative to the second strips avoids any interference caused by the polarized radio-electrical field emitted by the first element relative to the polarized radio-electrical field emitted by the second element.

What is more, the printed circuit antenna according to the invention is compact because the two feed lines have a common ground conductor plane including the two coupling slots and microstrips disposed on the same face of the first dielectric layer, and the strips of the radiating elements are superposed where they cross over.

The invention concerns an array of antennas including a plurality of first antennas whose first shorter strips are parallel to each other and whose second strips are also parallel to each other.

For this array of antennas to have crossed polarizations in each of the two frequency bands, it includes a plurality of second antennas whose shorter first strips and second strips extend coplanar and respectively perpendicular to the first strips and to the second strips of the first antennas.

The first antennas are divided into columns which are interleaved two by two with columns into which the second antennas are divided.

### BRIEF DESCRIPTION OF THE DRAWINGS

Other features and advantages of the present invention will become more clearly apparent on reading the following description of preferred embodiments of the invention, which description is given with reference to the corresponding accompanying drawings, in which:

FIG. 1 is a plan view of one embodiment of a dual band printed circuit antenna according to the invention;

FIG. 2 is a view of the dual band antenna in section taken along the broken line II-II in FIG. 1;

FIG. 3 is a plan view at the levels of feed lines and a ground plane with coupling slots in the dual band antenna shown in FIGS. 1 and 2;

FIG. 4 is a plan view of a smaller first radiating element associated with a higher frequency band and included in the dual band antenna shown in FIGS. 1 and 2;

FIG. 5 is a plan view of a larger second radiating element associated with a lower frequency band and included in the dual band antenna shown in FIGS. 1 and 2;

FIG. 6 is a diagrammatic perspective view of a one-dimensional array with two columns of elementary printed antennas in accordance with the invention for crossed radiated fields in each of two frequency bands; and

FIG. 7 is a diagrammatic perspective view of a two-dimensional array with elementary printed antennas according to the invention.

### DESCRIPTION OF THE PREFERRED EMBODIMENTS

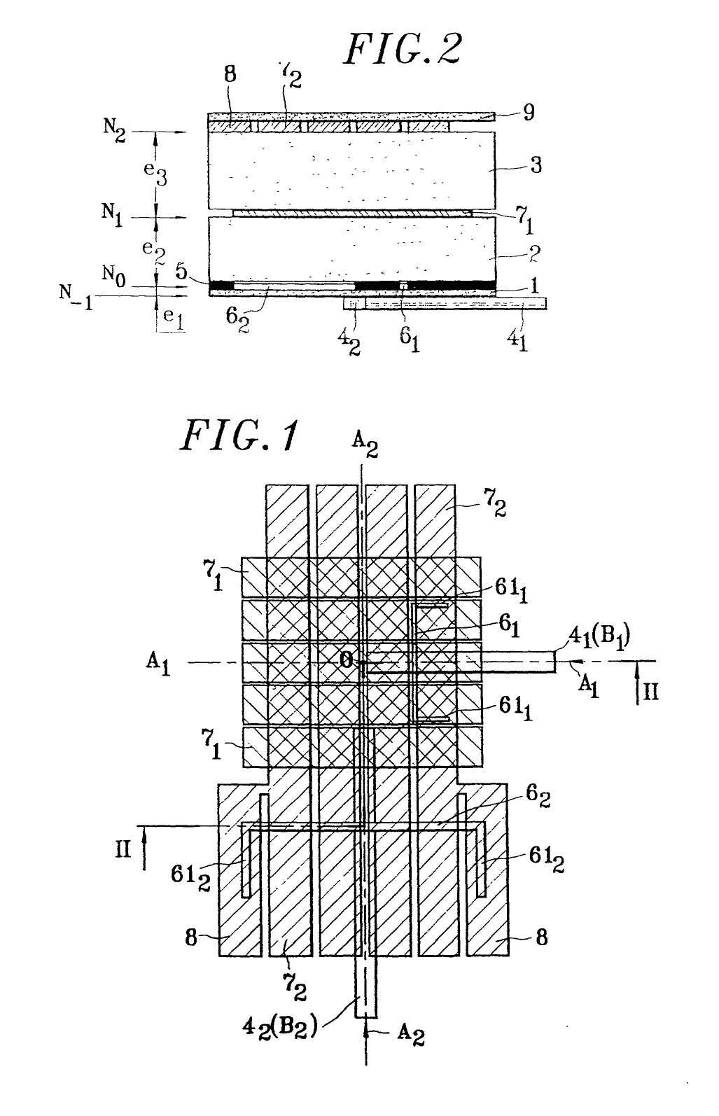

The following description of an elementary dual band printed antenna according to a preferred embodiment of the invention, illustrated virtually full size in FIGS. 1 to 5, provides numerical values by way of example for an antenna designed to operate in a first frequency band B₁, referred to as the upper band, from 1 710 MHz to 1 880 MHz, corresponding to radiotelephone communications conforming to the DCS-1800 standard, and in a second band B₂, referred to as the lower band, from 890 MHz to 960 MHz, for radiotelephone communications conforming to the GSM standard.

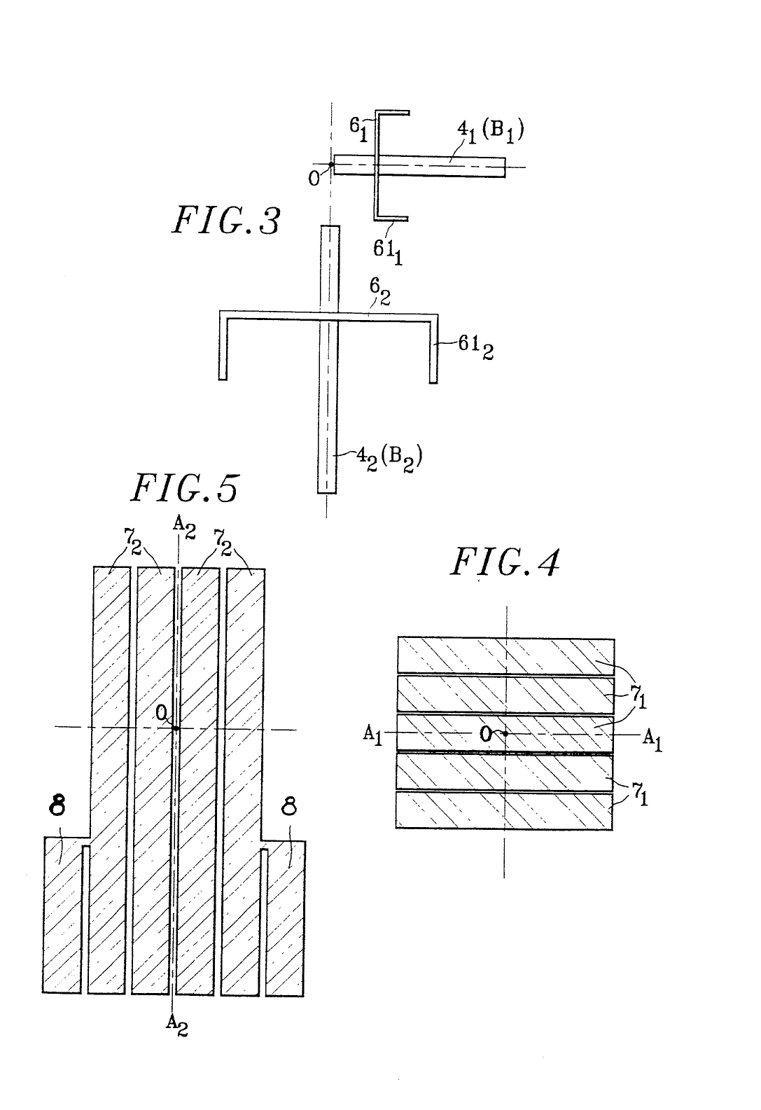

As shown in FIG. 2, the dual band antenna has three stacked dielectric layers: a Duroid first layer 1 having a relative dielectric permittivity ∈r₁=2.2 and a thickness e₁=1.5 mm, a second layer 2 made from dielectric foam having a relative dielectric permittivity ∈r₂=1.05 and a thickness e₂=15 mm, and a third layer made in dielectric foam having a relative dielectric permittivity ∈r₃=1.05 and a thickness e₃=20 mm. The antenna has four stacked levels of electrical conductors N₋₁ to N₂ separated by the three dielectric layers, as shown by stracking in FIG. 1. The level N₋₁ on the bottom face of the antenna, i.e. on the outside face of the first dielectric layer 1, includes two perpendicular microstrips 4₁ and 4₂ for the respective microwave feed lines in the frequency bands B₁ (upper band) and B₂ (lower band). The microstrips 4₁ and 4₂ can extend as far as a “crossover” point O of the perpendicular longitudinal axes of symmetry A₁A₁ and A₂A₂ of the radiating elements 7₁ and 7₂. As shown in FIG. 3, the level N₀ between the first and second dielectric layers 1 and 2 includes a ground conductor plane 5 in which are formed a first coupling slot 6₁ extending perpendicular to the first microstrip 4₁ and symmetrical with respect to the latter and a second coupling slot 6₂ extending perpendicular to the second microstrip 4₂ and symmetrical with respect to the latter. The first slot 6₁ is 28.7 mm long and shorter than the second slot 6₂ which is 59 mm long. The microstrips 4₁ and 4₂ extend beyond the respective coupling slots 6₁ and 6₂ over substantially less than a quarter of the respective wavelength. The third level N₁ also shown in FIG. 4 includes a striated first radiating element made up of five parallel narrow metal strips 7₁ extending perpendicular to and on top of the first slot 6₁, to which they are coupled, without covering the second slot 6₂, and symmetrically and equally distributed with respect to an axial plane of symmetry A₁A₁ longitudinal to the first microstrip 4₁. The fourth level N₂ also shown in FIG. 5 includes a striated second radiating element made up of four parallel narrow metal strips 7₂ extending perpendicular to and on top of the second slot 6₂, to which they are coupled, crossing the strips 7₁ on top of them, and symmetrically and equally distributed with respect to an axial plane of symmetry A₂A₂ longitudinal to the second microstrip 4₂. The second strips 7₂ are therefore perpendicular to the first strips 7₁.

A thin dielectric fourth layer 8 covers the metal strips 7₁ on top of the third dielectric layer 3 to provide a protective cover for the antenna.

The printed antenna according to the invention therefore combines in a compact manner two sub-antennas respectively operating in the frequency bands B₁ and B₂. The printed antenna typically extends over a maximum length of 130 mm along the longitudinal axis of the metal strips 7₂ and over a maximum width of 80 mm along the longitudinal axis of the metal strips 7₁.

The first sub-antenna consists of the microstrip feed line 4₁ matched to an impedance of 50 Ω, the coupling slot 6₁ and the radiating element metal strips 7₁. This first sub-antenna operates in the higher frequency band B₁ and with a polarization of the electrical field radiated by the first sub-antenna parallel to the metal strips 7₁, i.e. perpendicular to the coupling slot 6₁. The five strips 7₁ are typically inscribed in a rectangle 58 mm long by 50 mm wide spaced in pairs at 0.75 mm.

The second printed sub-antenna consists of the microstrip feed line 4₂ matched to an impedance of 50 Ω, the slot 6₂ and the radiating element metal strips 7₂. The second sub-antenna operates in the lower band B₂ and with a polarization of the electric field parallel to the metal strips 7₂, i.e. perpendicular to the coupling slot 6₂, and thus perfectly perpendicular to the polarized electrical field produced by the first sub-antenna. Thus the radio-electrical field in the second strip B₂ produced by the second sub-antenna is perfectly orthogonal to the radio-electrical field in the strip B₁ produced by the first sub-antenna, which avoids mutual interference of the radio-electrical fields between the bands. The metal strips 7₂ of the second sub-antenna are spaced by a thickness e₂+e₃ relative to the ground conductor plane 5 greater than the thickness e₂ between the metal strip 7₁ of the first sub-antenna relative to the ground conductor plane 5, because the second sub-antenna radiates in a frequency band B₂ lower than the frequency band B₁ of the first sub-antenna. Likewise, the coupling slot dimensions being substantially inversely proportional to the center frequency of the frequency band, the dimensions of the first coupling slot 6₁ are respectively smaller than the dimensions of the second coupling slot 6₂. Typically, each strip B₂ is 114 mm long and 10 mm wide and is at a distance of 2 mm from another strip.

In practice, the microstrips, ground plane and metal strips in the levels N₋₁ to N₂ are etched on the faces of the respective dielectric layers.

In particular, the coupling slots 6₁ and 6₂ is U-shaped and respectively symmetrical to the longitudinal axes of the microstrips 4₁ and 4₂, and thus have each two lateral branches 61₁, 61₂ parallel to the conductive strips of the respective radiating element 7₁, 7₂ and having respective lengths of 9 mm and 18.2 mm, as shown in FIG. 3. This helps to reduce the overall size of the microstrip radiating elements 7₁, 7₂ and to limit the radiation therefrom in the ground plane 5, at the same time guaranteeing a relatively wide frequency band B₁, B₂.

The strips 7₁ do not cover the second slot 6₂ as this would short-circuit the second radiating element operating in the lower frequency band B₂. The strips 7₂ do not totally cover the striated strips 7₁, in particular at their longitudinal ends, as this would short-circuit the first radiating element radiating in the upper band B₁. This imposes a very severe constraint on the width of the strips 7₂, which is normally imposed by the size of the coupling slot 6₂. That size is of the order of one half-wavelength. For the slots to be as short as possible, the coupling slots are angled.

The two farthest away conductor strips in the second radiating element 7₂ are doubled along a portion of their length that is not covered by the strip 7₁ by two supplementary lateral strips 8 superposed on the respective lateral branches 61₂ of the second coupling slot 6₂. This disposition of the lateral strips 8 also helps to widen the frequency band B₂ and to ensure correct coupling between the line 4₂ and the radiating element 7₂ for the frequency band B₂.

Measurements have shown that the printed antenna in accordance with the invention described above offered a standing wave ratio less than 1.5 over more than 10% of the bandwidth in each of the two bands B₁ and B₂, a decoupling between the polarized fields radiated in the two bands of the order of at least −30 dB, thanks in particular to the spatial filtering introduced by the two polarization grids formed by the metal strips 7₁ and 7₂, and radiation diagrams that are substantially symmetrical in respective principal planes perpendicular to the planes of the grids of metal strips 7₁ and 7₂ and passing through their axes of symmetry A₁A₁ and A₂A₂.

The radio-electrical performances of the printed antenna described above are preserved if a plurality of elementary printed antennas in accordance with the invention are juxtaposed to form a dual polarization array for each of the operating frequency bands B₁ and B₂. The feed lines, such as the lines 4₁ and 4₂, are advantageously disposed opposite the radiating elements consisting of the grids of metal strips 7₁ and 7₂ relative to the ground plane 5 to prevent mutual interference between signals transmitted in the bands B₁ and B₂.

A first embodiment of an antenna array includes a column C₁ of first printed circuit antennas oriented in the same fashion and a column C₂ of second antennas oriented in the same fashion and perpendicularly to the orientation of the first antennas, or more generally columns C₁ and C₂ which alternate and whose etching levels N₋₁ to N₂ are common, as shown in FIG. 2. In the first column C₁, the first strips 7₁ of the first antennas are disposed vertically to radiate a vertically polarized electrical field and are therefore fed by a common microstrip feed line 4V₁, and the second strips 7₂ of the first antennas are disposed horizontally to radiate a horizontally polarized electrical field and are fed by a microstrip common feed line 4H₁. Symmetrically, in the second column C₂, the first strips 7₁ of the second antennas are disposed horizontally and are fed by a common microstrip feed line 4H₂ in order to radiate a horizontally polarized electrical field which is therefore crossed perpendicularly with the electrical field radiated by the strips 7₁ in the first column C₁ for operation in the common first frequency band B₁; likewise, in the second column C₂, the second strips 7₂ of the second antennas are disposed perpendicularly to the second strips 7₂ included in the first column C₁ so as to radiate a vertically polarized electrical field crossed perpendicularly with the electrical field radiated by the strips 7₂ in the first column C₁ for operation in the common second frequency band B₂, the strips 7₂ in the column C₂ being fed by a common microstrip feed line 4V₂. Each microstrip feed line feeding the respective antennas has a tree-like structure and constitutes a power distributor at each node.

This first type of array, shown in FIG. 6, can constitute an antenna for a dual polarization and dual band base station for the GSM and DCS radiotelephone networks. As a function of the orientation of the antenna, the latter has directional diagrams in elevation and broad diagrams in azimuth for two orthogonal polarizations, respectively horizontal and vertical polarizations or polarizations at −45° and +45° to the horizontal.

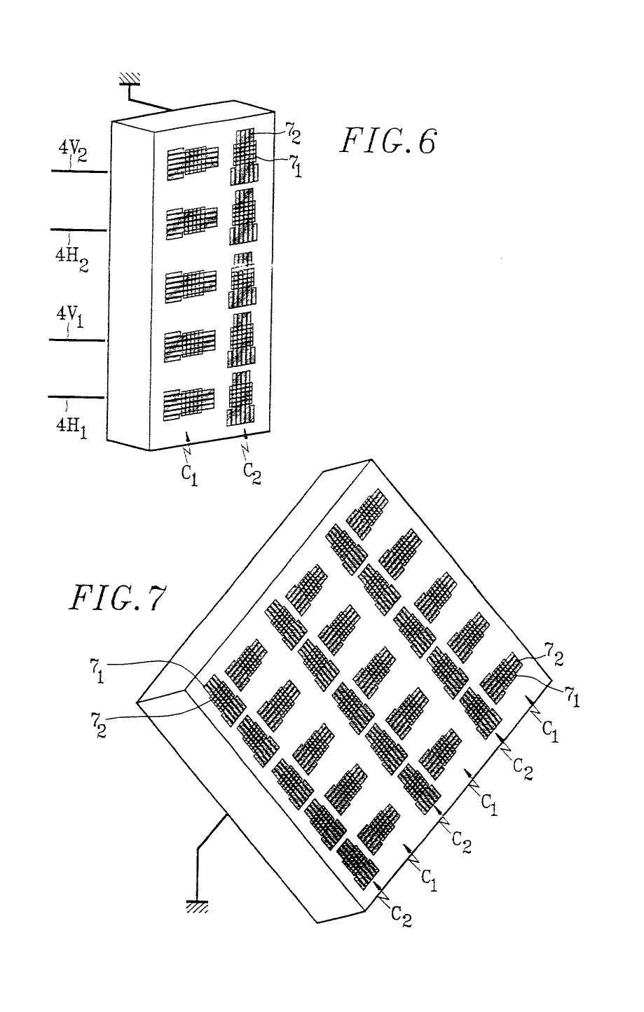

As shown in FIG. 7, a dual polarization and dual frequency band array of antennas can include a plurality of parallel columns C₁ and C₂ alternating in a plane. A two-dimensional array of antennas of this kind can constitute an antenna for a ground receiver station in a cellular radiocommunication system using a constellation of geostationary or non-geostationary satellites, for example.

Although the invention is described with reference to microstrip feed lines, the person skilled in the art will know how to replace them with striplines or coaxial lines. For a stripline, a supplementary dielectric layer is provided against the bottom face of the first dielectric layer 1, under the etching level N₋₁, with reference to FIG. 2, and a reflector ground conductor plane is printed on the bottom face of the supplementary dielectric layer.

What we claim is

1. A printed antenna comprising a first dielectric layer (1), a second dielectric layer (2), a first microwave feed line having a first microwave strip (4₁) disposed on an outside face of the first layer and a ground conductor plane (5) disposed between the first and second layers, and a first radiating element disposed on another face of the second layer and including a plurality of first narrow conductive strips (7₁) perpendicular to a first coupling slot (6₁) in the conductor plane for coupling the first feed line to the first radiating element, characterized in that it includes a second microwave feed line constituted by a second microstrip (4₂) disposed on the outside face of the first layer (1) perpendicularly to the first microstrip (4₁) and by said ground conductor plane (5), a third dielectric layer (3) having a face disposed against the first radiating element (7₁), and a second radiating element disposed on another face of the third layer and including a plurality of second narrow conductive strips (7₂) crossing perpendicularly by superposition the first conductive strips (6₁) and extending perpendicular to a second coupling slot (6₂) in the ground conductor plane (5) for coupling the second feed line to the second radiating element.

2. An antenna according to claim 1, characterized in that the second radiating element (7₂) radiates in a second frequency band lower than a first frequency band in which the first radiating element (7₁) radiates, and the dimensions of the first coupling slot (6₁) are respectively smaller than the dimensions of the second coupling slot (6₂).

3. An antenna according to claim 1 or 2, characterized in that at least one of the coupling slots (6₁, 6₂) has a U-shape with lateral branches (61₁, 61₂) parallel to the conductive strips of the respective radiating element (7₁, 7₂).

4. An antenna according to claim 3, characterized in that the two strips (7₂) farthest apart in the second radiating element have lateral strips (8) respectively superposed on the lateral branches (61₂) of the second coupling slot (6₂).

5. An array of antennas including a plurality of first antennas (C₁) according to claim 1 and whose first shorter strips (7₁) are parallel to each other and whose second strips (7₂) are also parallel to each other.

6. An antenna array according to claim 5, characterized in that it includes a plurality of second antennas (C₂) according to any of claims 1 to 4 and whose shorter first strips (7₁) and second strips (7₂) extend coplanar and respectively perpendicular to the first strips (7₁) and to the second strips (7₂) of the first antennas (C₁).

7. An antenna array according to claim 6, characterized in that the first antennas are divided into columns (C₁) which are interleaved two by two with columns (C₂) into which the second antennas are divided.
